(19) United States
(12) Patent Application Publication
(10) Pub. No.: US 2006/0081736 A1
(43) Pub. Date: Apr. 20, 2006

(54) Support slide for cable management arm

(76) Inventors: Ken-Ching Chen, Kaohsiung Hsien (TW); Shun-Ho Yang, Kaohsiung Hsien (TW); Shih-Long Hwang, Kaohsiung Hsien (TW); Chun-Chiang Wang, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/014,976

(22) Filed: Dec. 20, 2004

Related U.S. Application Data
(63) Continuation-in-part of application No. 10/964,708, filed on Oct. 15, 2004.

(51) Int. Cl. F16L 3/00

(52) U.S. Cl. 248/68.1

(57) ABSTRACT

A support slide adapted to a cable management arm and two slides; two ends of the cable management arm inserted to and sliding on the slides; a sliding member provided between the two ends of the cable management arm and sustained by the support slide to travel in relation to the support slide; two ends of the support slide inserted and sliding on the two slides; the support slide being inserted and sliding on the slides with two sliding blocks; a first rod and a second rod of the support slide sliding into each other to become one retractable piece allowing change of its total length; the two rods of the support slide each pivoted to a sliding block sliding.

### BACKGROUND OF THE INVENTION

(a) Field of the Invention

This application is a continuation-in-part of my application filed on Oct. 15, 2004, Ser. No. 10/964,708. This invention relates to a support slide adapted to a cable management arm, and more particularly, to one that is retractable to change its total length with two ends respectively pivoted to a sliding block and two sliding blocks are respectively inserted to slide onto two slides.

(b) Description of the Prior Art:

A conventional electronic product, such as a server, mounted on a slide-in chassis, has been provided on its both sides each a slide to travel on both slides, and a cable management arm to contain and restrict the cable.

As taught in U.S. Pat. Nos. 4,353,518; 4,614,383, 5,571,256, 6,303,864B1, 6,305,556B1, 6,442,030B1, 6,600,665B1, and US Patent Application Nos. 2003/0026084A1, 2003/0222034A1, and 2004/0079711A1, the cable management arm is usually adapted with two slides having two ends as supports. A retractable member, generally in a form of a hinge, is provided between the two ends of the cable management arm. The retractable member when retracted is suspended to stay away from either end. However, the retractable member of the cable management arm tends to droop over a certain period of time to negatively affect the operation in a highly intensively slide-in space due to the mass of the cable and the cable management arm.

### SUMMARY OF THE INVENTION

The primary purpose of the present invention is to provide a support slide adapted to a cable management arm and two slides. Two ends of the cable management arm are inserted to and slide on the two slides; a sliding member is provided between the two ends of the cable management arm; two ends of the support slide are respectively inserted to and slide on the two slides; and the sliding member held by the support slide slides in relation with the support slide. To achieve the purpose, the support slide includes two sliding blocks, a first rod, a second rod, and two pivoting pins. The two sliding blocks are respectively inserted to and slide on the slides; both of the first and second rods are inserted to each other in one piece to become retractable for changing its total length respectively pivoted to a sliding block with the pivoting pin; and a slot is provided on the first rod for the sliding member to travel thereon.

### BRIEF DESCRIPTION OF THE DRAWINGS

FIG. 1 is an exploded view of a first preferred embodiment of the present invention.

FIG. 2 is a top view of the first preferred embodiment of the present invention.

FIG. 3 is a top view showing the operation of the first preferred embodiment of the present invention.

FIG. 4 is another top view showing the operation of the first preferred embodiment of the present invention.

FIG. 5 is a perspective view showing connection between a support slide and a slide in a second preferred embodiment of the present invention.

FIG. 6 is a perspective view showing connection between a support slide and a slide in a third preferred embodiment of the present invention.

FIG. 7 is a perspective view showing connection between a support slide and a slide in a fourth preferred embodiment of the present invention.

### DETAILED DESCRIPTION OF THE PREFERRED EMBODIMENTS

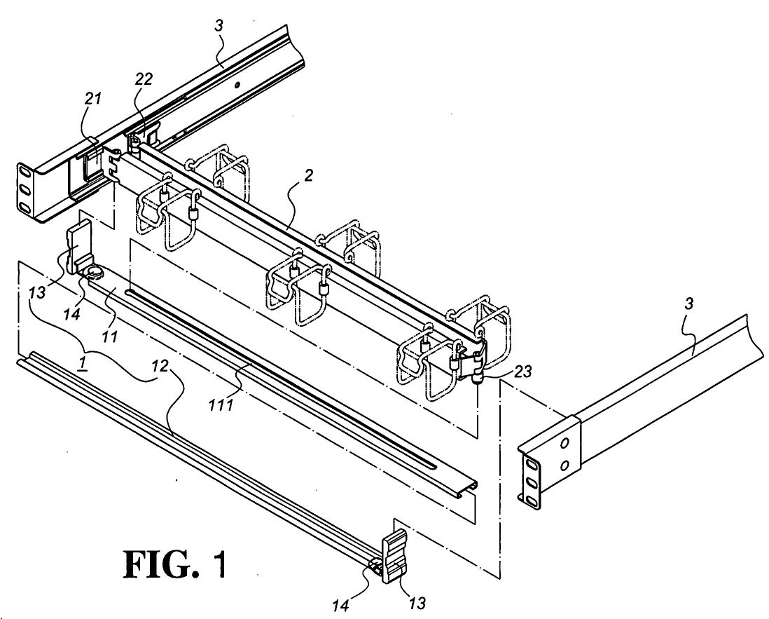

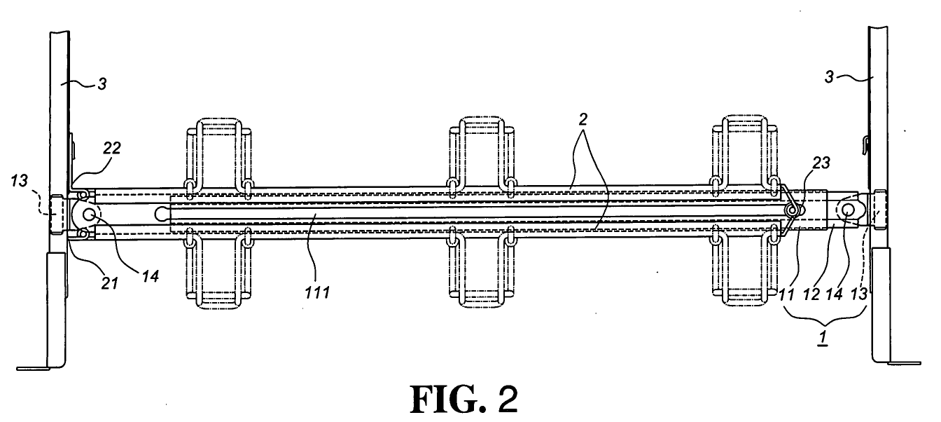

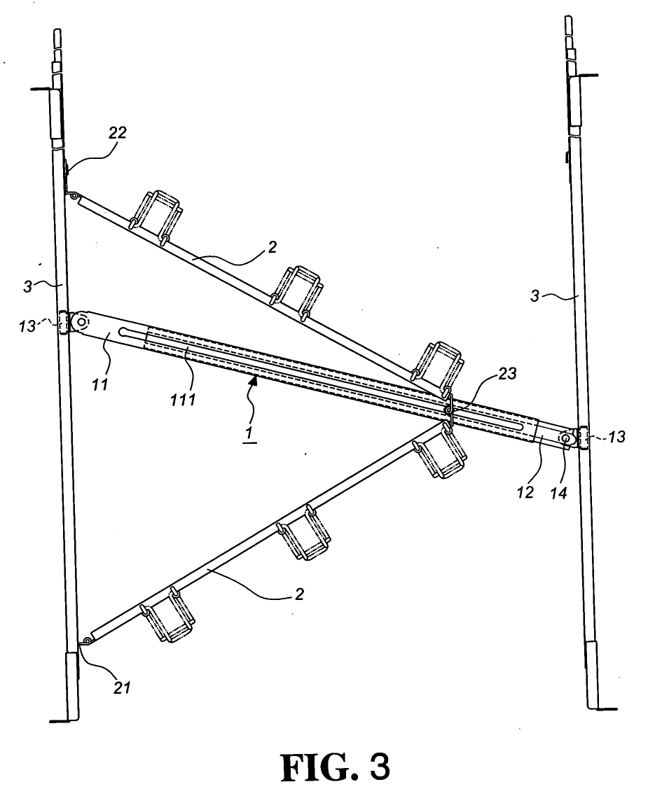

Referring to FIGS. 1, 2, and 3 for a first preferred embodiment of the present invention, a support slide (1) is adapted to a cable management arm (2) and two slides (3). Wherein, two ends (21, 22) of the cable management arm (2) are inserted to slide on the slides (3); a sliding member (23) is provided between the two ends (21, 22) of the cable management arm (2); two ends of the support slide (1) are also respectively inserted to and slide on the slides (3); and the sliding member (23) sustained by the support slide (1) slides in relation with the support slide (1).

The support slide (1) includes a first rod (11), a second rod (12), two sliding block (13), and two pivoting pins (14). The sliding blocks (13) are respectively inserted to and slide on the slides (3). The first rod (11) and the second rod (12) are respectively pivoted to the sliding blocks (13) by means of the pivoting pins (14). Both the first rod (11) and the second rod (12) slide into each other to become one retractable piece allowing change of its total length. A slot (111) is provided on the first rod (11) to receive insertion of the sliding member (23) for it to slide in the slot (111).

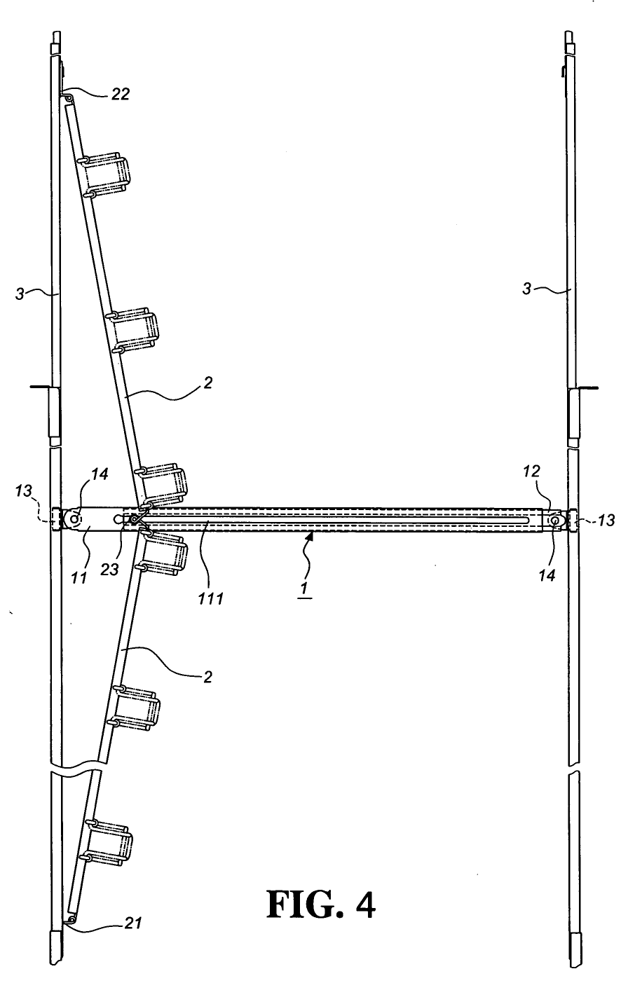

As illustrated in FIG. 4, the first preferred embodiment of the present invention when in operation, the support slide (1) is retractable and in a position at a certain inclination in relation to the slides (3) due to the first rod (11) and the second rod (12). Accordingly, when the cable management arm (2) stretches out or closes in, the sliding member (23) is allowed to easily slide in the slot (111) while driving the support slide (1) to travel in relation to the slides (3) by means of the sliding blocks (13) of the support slide (1). Meanwhile, the weight of the cable management arm (2) and the cable are jointly born by the two ends (21, 22) of the cable management arm (2) and the two sliding blocks (13) respectively deposited on the two ends of the support slide (1).

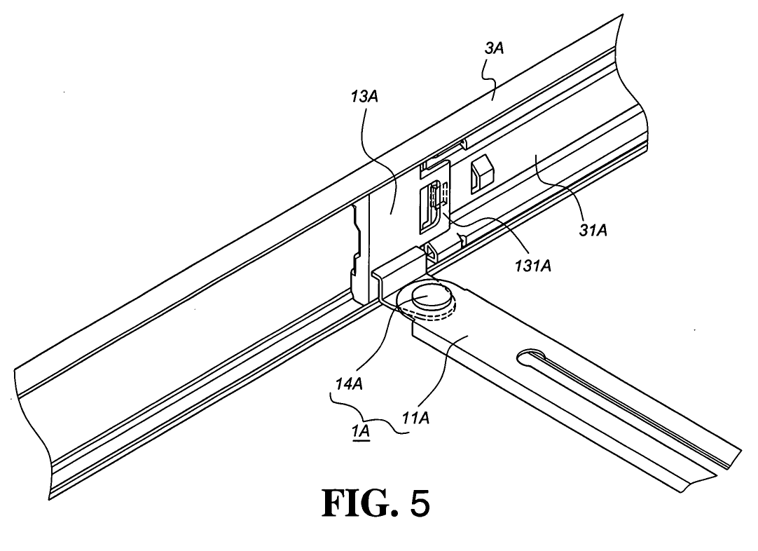

FIG. 5 is a perspective view of a second preferred embodiment of the present invention showing that a support slide (1A) is connected to a slide (3A). Wherein, a first rod (11A) each on two ends of the support slide (1A) is pivoted to a sliding block (13A) by means of a pivoting pin (14A); a joint (131A) is provided on the sliding block (13A) for the sliding block (13A) to connect to the rear end of a guide rod (31A) in the slide (3), and thus to synchronously travel with the guide rod (31A).

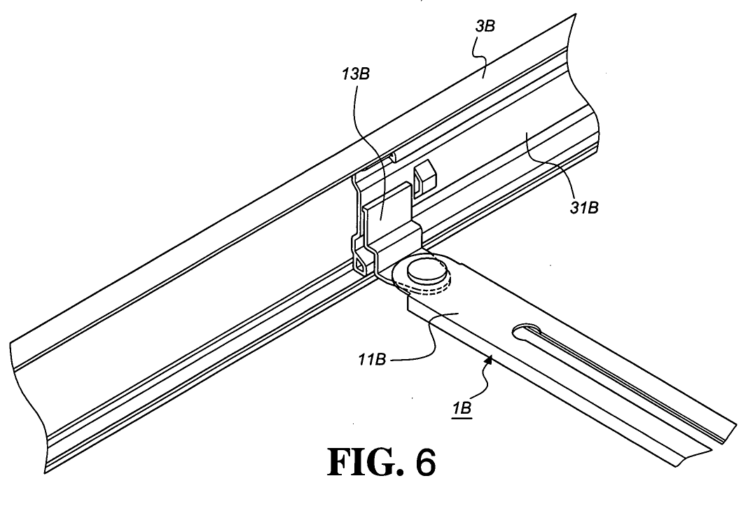

Furthermore, as illustrated in FIG. 6 showing a- connection between a support slide (1B) and two slides (3B) in a third preferred embodiment of the present invention, a first rod (11B) each on two ends of the support slide (1B) is directly connected to the rear end of a guide rod (31B) provided in the slide (3B) by means of a sliding block (13B) thus for the first rod (11B) to travel as the guide rod (31B) slides.

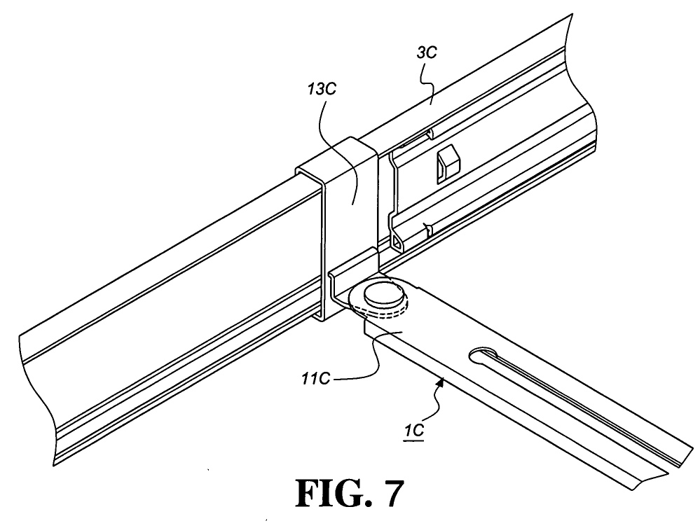

As illustrated in FIG. 7 for a perspective view of a connection between a support slide (1C) and two slides (3C) in a fourth preferred embodiment of the present invention, the support slide (11C) and the slide (3C) are connected in a fashion that a sliding block (13C) connecting the support slide (11C) is made in a form of a square ring with the slide (3C) inserted through therein.

What is claimed is:

1. A support slide adapted to a cable management arm and two slides; two ends of the cable management arm being inserted to and sliding on the slides; a sliding member being provided between the two ends of the cable management arm; two ends of the support slide being inserted to and sliding on the slides; the sliding member traveling in relation with the support slide; the sliding member being sustained by the support slide; and characterized in that:
the support slide comprising two sliding blocks, a first rod, a second rod, and two pivoting pins; the sliding blocks respectively being inserted to and sliding on the slides; the first and the second rods each being pivoted to a sliding block by means of a pivoting pin; the first rod and the second rod being inserted into each other to become one retractable piece allowing change of its total length; and a slot being provided in the first rod for the sliding member to travel therein.

2. The support slide for a cable management arm of claim 1, wherein a joint is provided to the sliding block of the support slide of the cable management arm to connect the support slide to a rear end of a guide rod in the slide.

3. The support slide for a cable management arm of claim 1, wherein the sliding block of the support slide of the cable management arm is directly connected to the rear end of the guide rod in the slide.

4. The support slide for a cable management arm of claim 1, wherein the sliding blocks at the two ends of the support slide of the cable management arm are made in a form of a square ring.
